(19) United States
(12) Patent Application Publication
(10) Pub. No.: US 2003/0069811 A1
(43) Pub. Date: Apr. 10, 2003

(54) On-demand reproduction of visual images

(76) Inventors: Ricardo C. Ximenes, Los Lunas, NM (US); Rupert L. Watson, San Francisco, CA (US)

Correspondence Address: V. Gerald Grafe, esq., P.O. Box 2689, Corrales, NM, 87048, US

(21) Appl. No.: 09/974,621

(22) Filed: Oct. 10, 2001

(51) Int. Cl. G06F 17/60

(52) U.S. Cl. 705/27

(57) ABSTRACT

The present invention provides a method and apparatus for producing reproductions of visual images on demand. The method comprises assembling a computer-readable library of visual images for which reproductions are available. Ordering portals provide user access to the library. An order placed through a portal can comprise payment information and a specification of a visual image. A print facility can produce the ordered reproduction. The payment associated with the reproduction can be apportioned according to an owner of rights in the visual image and an owner of the ordering portal.

### BACKGROUND OF THE INVENTION

This invention relates to the field of reproduction of visual images, specifically on-demand, high quality reproduction of visual images selected from a computer-accessible library of visual images.

High quality reproductions of desirable visual images have long been in demand. Patrons see an image in, for example, a museum collection or an art display, and desire to have the image for their private enjoyment. Reproductions ranging from low quality posters to high quality, restricted production prints are available for a large number of visual images, but even the large number is a very small portion of the total number of images extant. Also, existing reproductions are pre-produced and available only from specific locations (e.g., museum stores). They are also available in only a limited number of formats (e.g., only a few sizes, often no choice as to framing or substrate). Pre-producing and inventorying reproductions of a large number of images can be prohibitively expensive. Also, the rights to the images, productions costs, inventory costs, and sales costs must all be allocated in advance, while there is still significant risk in incorrect predictions of market demand, leading to inefficient allocation of resources and further driving up the cost and down the supply of reproductions. Consequently, the public must settle for limited choices, and can not obtain full enjoyment of images such as museum works of art.

Accordingly, there is a need for a method of producing high quality reproductions of visual images, in a variety of formats and from a variety of sources, that does not require cost-prohibitive pre-production and inventory.

### SUMMARY OF THE INVENTION

The present invention provides a method and apparatus for producing reproductions of visual images on demand. The method comprises assembling a computer-readable library of visual images for which reproductions are available. Ordering portals provide user access to the library. An order placed through a portal can comprise payment information and a specification of a visual image. A print facility can produce the ordered reproduction. The payment associated with the reproduction can be apportioned according to an owner of rights in the visual image and an owner of the ordering portal.

Assembling the computer-readable library can include generating a digital image of each visual image, to facilitate on-line or other computer-enabled browsing. It can also include generating a print file for each visual image, where a print file can be proofed and curated as described below to produce a print file that can effectively produce reproductions of desirable quality. The computer-readable library can associate the digital image and the print file, so that ordering from the digital image initiates production of a reproduction at the print facility from the print file.

The apportionment of payment according to an owner of the visual image and the owner of the ordering portal can encourage a wide variety of reproductions to be available to the public. Visual images in private collections, in museum collections but not on display, or not available for reproduction due to low aggregate demand can all be accommodated by the present invention. Instead of expensive physical inventory of reproductions, the present invention allows digital storage of print files. The present invention also provides for incentives (via apportioned payment) to owners of visual images, and to owners of likely ordering portals (also via apportioned payment).

An apparatus according to the present invention can comprise a catalog server and ordering server, in communication with ordering portals and in communication with one or more print facilities. Users can interact with the catalog server to search available images, and with the ordering server to specify an order for a reproduction. The order can include specification of a format for the reproduction, where a format can include specification of characteristics such as the substrate (e.g., paper or canvas), packaging (e.g., framed or unframed), delivery instructions, and size. The user can accomplish such interaction over computer networks such as the internet, and can provide for payment using contemporary e-commerce techniques. The order server can communicate with the print facility in similar manner. The print facilities can comprise a digital wide format printer.

Advantages and novel features will become apparent to those skilled in the art upon examination of the following description or may be learned by practice of the invention. The objects and advantages of the invention may be realized and attained by means of the instrumentalities and combinations particularly pointed out in the appended claims.

### DESCRIPTION OF THE FIGURES

The accompanying drawings, which are incorporated into and form part of the specification, illustrate embodiments of the invention and, together with the description, serve to explain the principles of the invention.

FIG. 1 is a schematic representation of a system according to the present invention.

FIG. 2 is a flow diagram of steps in a method according to the present invention.

FIG. 3 is a schematic representation of a system according to the present invention.

FIG. 4 is a schematic representation of a system according to the present invention.

FIG. 5 is a schematic representation of a system according to the present invention.

### DETAILED DESCRIPTION OF THE INVENTION

The present invention provides a method and apparatus for producing reproductions of visual images on demand. The method comprises assembling a computer-readable library of visual images for which reproductions are available. Ordering portals provide user access to the library. An order placed through a portal can comprise payment information and a specification of a visual image. A print facility can produce the ordered reproduction. The payment associated with the reproduction can be apportioned according to an owner of rights in the visual image and an owner of the ordering portal.

Assembling the computer-readable library can include generating a digital image of each visual image, to facilitate on-line or other computer-enabled browsing. It can also include generating a print file for each visual image, where a print file can be proofed and curated as described below to produce a print file that can effectively produce reproductions of desirable quality. The computer-readable library can associate the digital image and the print file, so that ordering from the digital image initiates production of a reproduction at the print facility from the print file.

The apportionment of payment according to an owner of the visual image and the owner of the ordering portal can encourage a wide variety of reproductions to be available to the public. Visual images in private collections, in museum collections but not on display, or not available for reproduction due to low aggregate demand can all be accommodated by the present invention. Instead of expensive physical inventory of reproductions, the present invention allows only digital storage of print files. The present invention also provides for incentives (via apportioned payment) to owners of visual images, and to owners of likely ordering portals (also via apportioned payment).

An apparatus according to the present invention can comprise a library server and ordering server, in communication with the ordering portals and in communication with one or more print facilities. Users can interact with the library server to search available images, and with the ordering server to specify an order for a reproduction. The order can include specification of a format for the reproduction, where a format can include specification of characteristics such as the substrate (e.g., paper or canvas), packaging (e.g., framed or unframed), delivery instructions, and size. The user can accomplish such interaction over computer networks such as the internet, and can provide for payment using contemporary ecommerce techniques. The order server can communicate with the print facility in similar manner. The print facilities can comprise a digital wide format printer such as printers made by Epson, Roland, and Iris. See, e.g., FineArtGigleePrinters.org webpage, incorporated herein by reference.

System Description

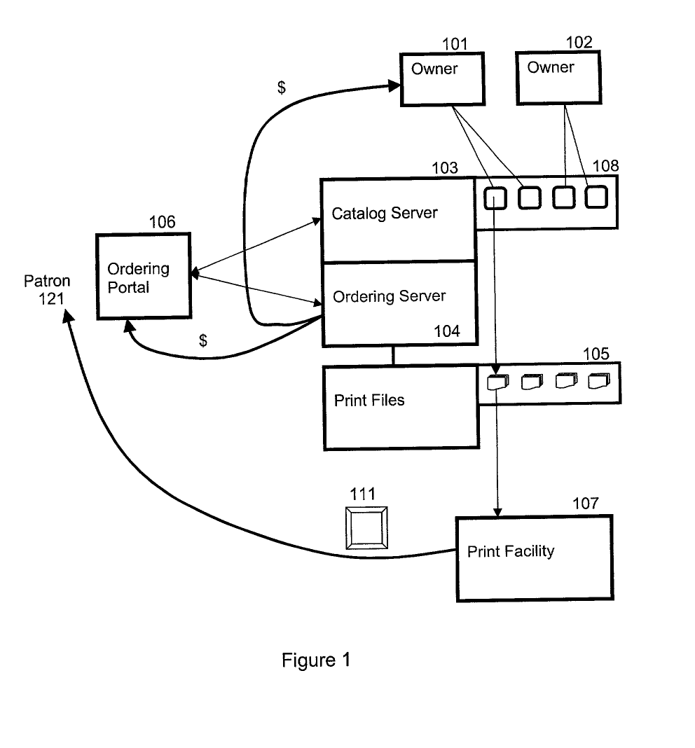

FIG. 1 is a schematic representation of a system according to the present invention. A catalog 108 comprises information identifying visual images available for reproduction, where the rights in such visual images are owned by one or more of owners 101, 102. A catalog server 103 manages access to the catalog 108. A patron 121 can access the catalog 108 via a portal 106, for example, by using a web browser on a computer at the portal 106 to interact with web services provided by the catalog server 103. The patron 121 can identify a visual image to be reproduced from the catalog 108 and provide payment information to an ordering server 104. The ordering server 104 can be integrated with the catalog server 103. The ordering server can be, for example, a web-based e-commerce ordering service such as are in contemporary use.

On successful completion of an order, the ordering server 104 can access a print file 105 associated with the identified visual image. The print file 105 can provide information needed for a print facility 107 to produce the reproduction specified in the order. For example, the print file can comprise a digital file that is suitable as input to a digital giclee printer. The reproduction from the print facility 107 can be delivered to the patron 121 (or elsewhere according to the patron's order). The ordering server 104 can apportion the payment from the patron 121, for example, by apportioning part of the payment to the owner 101 of the identified visual image and part to the owner of the ordering portal 106. The ordering server 104 can also provide for payment to service providers such as the print facility, materials suppliers, and shipping providers.

Catalog Server

A catalog server can comprise a contemporary computer such as those widely used for servers and web hosts. The catalog server can have accessible storage of sufficient capacity to store the information required in the catalog, including the print files if they are not stored elsewhere in the system. The catalog server can also comprise database software known to those skilled in the art, such as those from New Mexico Software, Oracle, Microsoft Access, or MySQL. See, e.g., New Mexico Software webpage, incorporated herein by reference. The database software can be customized to provide the desired the catalog characteristics using computer programming techniques known to those skilled in the art. The catalog server can also comprise computer communications capabilities such as an interface to the internet for communication with other parts of the system such as ordering portals.

Ordering Portal

An ordering portal can comprise a computer or network access device such as those in widespread contemporary use. Contemporary personal computers and web-accessing personal devices, for example, can be used as ordering portals. An ordering portal can communicate with the catalog server and ordering server using contemporary computer communications technology, such as, for example, the internet, private networks, and virtual private networks. An ordering portal can comprise computer software imparting the desired interface characteristics, such as, for example, a web client in communication with web servers comprising the catalog and ordering servers. The ordering portal can also comprise interface functionality in support of electronic commerce to facilitate payment.

Ordering Server

The ordering server, like a catalog server, can comprise a contemporary computer such as those widely used for servers and web hosts. The ordering server can have accessible storage of sufficient capacity to store the print files if they are not stored elsewhere in the system. The ordering server can also comprise computer communications capabilities such as an interface to the internet for communication with other parts of the system such as ordering portals. The ordering server can include electronic commerce software such as is in common use to accommodate payment. See, e.g., VeriSign webpage, incorporated herein by reference. The ordering server can be integrated with the catalog server if the computer hardware and software is amendable to such combination.

Print Facility

A print facility can comprise a digital wide format printer, capable of producing acceptable quality reproductions from digital print files. Suitable printers include models made by Epson, Roland, and Iris. Such a printer can be in communication with an ordering server, where the ordering server transmits to the print facility information required to produce the desired reproduction.

The required information can include the print file, or an identification of the print file. Suitable print files can be large relative to contemporary computer storage and communication bandwidth. If storage local to the print facility is more readily available relative to communication bandwidth, the print files can be stored at the print facility, and the ordering server need transmit only an identification of which print file to use. If communication bandwidth is more readily available relative to storage local to the print facility, then the print files can be stored at the ordering server (or catalog server, or other storage facility), and the print file itself transmitted to the print facility as part of the order transmission. The choice of storage location for print files can also depend on other concerns, such as, for example, information security concerns, need for central management, the total storage required for print files, and need for frequent updates. A mix can also be used, for example by storing frequently accessed print files local to the print facility and other print files at a central storage facility.

The quality of the reproduction can depend on the substrates and inks used in the print process. Canvas and acid-free rag paper, coated for digital printing, available in various thickness and weights, can be suitable substrates. Inks of suitable quality are generally available from the manufacturers of the printers.

Location of the print facilities can depend on various factors. For example, if the economic cost of the print facility is high, then a limited number of print facilities can be located at locations amendable to efficient shipping of reproductions. If, on the other hand, the economic cost of a print facility is low, then print facilities can be located near ordering portals to enable immediate delivery of the reproduction to the patron. Combinations of locations can be suitable, for example locating print facilities near high volume ordering portals, and using centralized print facilities to service lower volume ordering portals and as backups to other print facilities.

Method

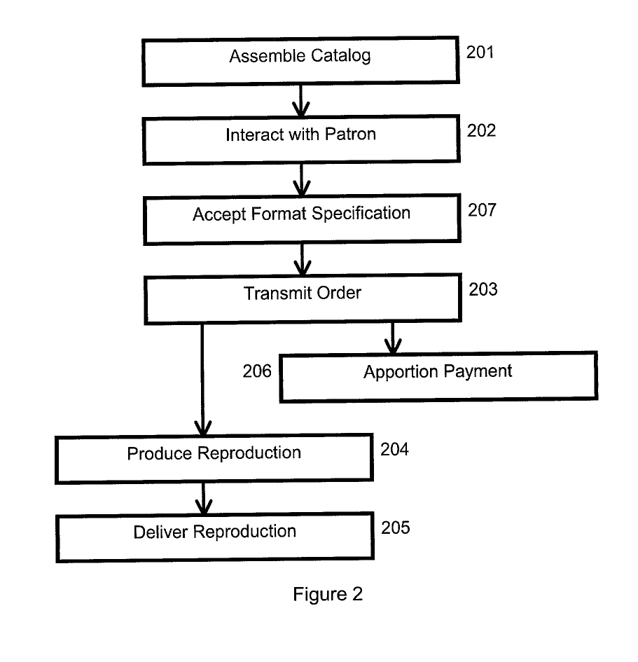

FIG. 2 is a flow diagram of steps in a method according to the present invention. Visual images from various owners can be assembled into a catalog 201. The catalog can include information that allows patrons to identify desired reproductions, and information that enables reproduction (for example, print files for controlling a digital giclee printer). Patrons then can interact with the catalog 202, for example by browsing or searching the catalog according to characteristics such as owner of the image, artist creating the image, period of creation of the image, genre, medium, price of a reproduction, colors, themes, content or subjects, style, rating by critics or other patrons, location of creation, suitability for a specific application, and specification of characteristics such as size, substrate, color, proportion, packaging, cropping, shipping destination, shipping method, and framing. The patron then can transmit an order 203 comprising identification of the visual image, payment information, and format information. Payment information can comprise, for example, an indication that cash payment was received by a representative or an electronic commerce payment mechanism. Transmission of information can include apportionment of payment 206 and transmission of print information to a print facility 204. A print facility can produce the reproduction and deliver it to the patron 205.

Assembling a Catalog

A catalog can be assembled from a plurality of visual images. For each image, the catalog can comprise a textual description of the image, a displayable reproduction of the image, identification of an owner of rights in the image, pricing of reproductions of the image, and specification of various other characteristics useful in accessing the catalog or producing the reproduction. As an example, to add a painting from a museum to a catalog, a transparency or other high resolution reproduction of the painting can be produced. From the transparency, a low resolution digital image can be produced to provide a displayable preview image of the reproduction. A high resolution digital image can also be produced from the transparency, and used to generate an initial print file. The print file can be used to control a giclee printer to produce a reproduction. The reproduction can be compared with the original painting or the transparency, and adjustments made to the print file. The process can repeat until the print file produces an acceptable quality reproduction. A text description can be associated with the low resolution digital image. Pricing information can also be associated with the catalog entry. The identification the museum can also be associated with the catalog entry. The items in the catalog can be encrypted to discourage unauthorized access, and the print files can further be accessible only indirectly from the catalog (e.g., as part of an order transmission to a print facility) to further discourage unauthorized access. An example catalog entry is shown in

[image]

The example in the Table illustrates some of the information that can be useful in a catalog. Multiple entries in a catalog can be stored and organized using, for example, computer database and storage technology such as those discussed above.

Interaction with a Patron

A patron considering ordering a reproduction can access the catalog via a portal. As an example, a portal can comprise a computer connected via a computer network to a catalog server. A portal computer can comprise software for communicating with the catalog server, or can comprise a standard web browser with a corresponding web-based catalog server. The catalog can also reside in whole or in part on the portal, for example comprising access software and catalog data on a computer-readable storage medium. Removable media can make updating the catalog convenient.

A patron interested in ordering a reproduction can first determine which visual image in the catalog is desired for reproduction. The catalog server (network-connected or local to the portal) can allow the patron to browse entries, for example by displaying low resolution digital images representative of available reproductions. The catalog server can also allow for searching of the catalog by various parameters. For example, a patron might desire to search for works by specific artists, works in specific genres, works owned by specific owners, or works with certain format reproductions available. Contemporary computer software can accommodate desirable catalog browsing and searching capabilities. Initial patron interest in a reproduction can be, for example, from access to the catalog, viewing the original image itself, or from a presentation of works available for reproduction.

The patron can also specify format information concerning the desired reproduction, as described below. The patron also can arrange for payment of the reproduction. Payment can be accomplished by contemporary electronic commerce techniques. On-site payment can also be used, with authorization for the order coming from a representative who accepts physical payment from the patron. Various billing, payment, and collection methods known in the art are also suitable for use with the present invention, including purchases, leases, and time payment plans.

Specifying a Format

The on-demand reproduction of visual images afforded by the present invention enables reproductions in a wider range of formats than was economical with prior methods. A single print file can accommodate a range of sizes for the reproduction, allowing a patron to order a reproduction in exactly the desired size. A single print file can also accommodate reproductions on a variety of substrates, for example paper and canvas, allowing a patron to specify the desired substrate. Various other format choices are also available, including, for example, aspect ratio (if the visual image is amenable to changing aspect ratio), post reproduction treatments (e.g., canvas stretching, framing options), colors (e.g., a reproduction of an exotic car can be produced in a variety of colors).

Transmitting an Order

An order comprising specification of the information required to produce the desired reproduction can be transmitted from the portal (using a local or centralized catalog server). An order server, either part of the local portal or in communication on another computer, can accept the order information and transmit appropriate information to a print facility. The print file associated with the order can be transmitted to the print facility, or can be stored at the print facility and identifying information transmitted. Storage at the print facility can reduce required communication bandwidth, but can also increase required storage (since each print facility might need copies of all the print files).

Apportioning Payment

The present invention allows payment for reproductions to apportioned among various participants. This can yield a simpler and more accurate distribution of economic benefits among many image owners, portal owners, print facilities, and others involved. As an example, each visual image can have a payment to the owner associated with each possible reproduction. Each order for a reproduction of a specific visual image can initiate payment of the indicated amount to the owner of the specific visual image. Computer implementation of the various aspects of the present invention allows such payment to be accomplished automatically, reducing the transaction burden and the possibility for error.

As another example, each reproduction can have an associated base price representing the cost of reproduction and the cost of maintaining the catalog and ordering servers. The purchase price for a reproduction can be established to be an amount greater than the base price (the margin), for example by a fixed amount or by a percentage. The margin can be apportioned among the various participants, for example by a portion to the owner of the image, another portion to the owner of the portal initiating the order, and a portion to the operator of the overall system. Computer implementation of the various aspects of the system can allow this apportionment to be done automatically, making complex apportionment among a large number of orders, portals, and owners economically feasible.

Printing the Reproduction

The reproduction can be produced on a suitable printer such as those described above. A contemporary computer can be used to control the printer. The computer can comprise image editing and printer control software, such as Adobe Photoshop for example, to control the printer and to allow adjustment of print files if needed. See, e.g., Adobe webpage, incorporated herein by reference. The print facility needs appropriate infrastructure to support the printer and computer, for example, power supply and environmental controls. The print facility also needs access to print files according to the print file storage strategy chosen. If print files are stored at the print facility, then the print facility can have storage accessible to the computer for print files. If print files are stored elsewhere then the print facility, then the print facility can have communication bandwidth, for example high bandwidth computer networks, to receive print files. The print facility can also have mechanisms to accommodate removeable computer storage media if print files are transmitted by delivery of physical media; for example, print files can be distributed on CDs or DVDs, and the print facility can access the CD or DVD needed for the reproduction ordered.

Delivering the Reproduction

The reproduction can be delivered according to a variety of shipping methods. Reproductions can be delivered directly to the ordering patron. They can also be delivered to a museum or collection, for display, inventory, or later delivery to the ordering patron. They can also be delivered to designers, architects, or other professionals for installation as part of their services. They can also be delivered to value-added partners, for example to frame shops for framing before delivery.

Producing Collections of Reproductions

The present invention also allows production of collections of reproductions. A patron can identify a plurality of visual images and associated formats for reproduction as described above for a single visual image. The plurality of reproductions can be produced as described above and delivered to the patron. The plurality can be assembled into a collection before delivery to the patron, for example by binding into a book. For binding into a book, a patron can also be allowed to specify a visual image for the cover or covers, various personal information such as dedications. Some or all of the visual images can have descriptions added to the book. An additional description, for example a biography of the artist or a description of the collection owing the original visual images, can also be added to the book.

Example Implementation

An example system according to the present invention can comprise a high resolution digital scanner such as models made by Polaroid, Linotype, and Nikon. The scanner can be configured to generate high resolution scans from photographic transparencies of visual images. The digital file generated by the scanner can be edited, for example using Adobe's Photoshop, to improve the quality of resulting reproductions. As examples, the scan file can be edited to remove artifacts such as scratches, to correct color, and to correct for printer performance characteristics. After editing, a master print file can be stored, where the master print file contains the information needed to produce an acceptable quality reproduction of the visual image.

A digital image can also be produced for catalog purposes. The catalog digital image can be of lower resolution that the master print file. The catalog images, along with identifying information such as that described above, can be stored on computer-accessible media, for example on disk or tape drives. The print files and catalog files can be compressed to reduce the storage space required. Access to the catalog can be provided using software that allows various browsing and searching functions. The catalog access software can be configured to communicate with contemporary web browsers, allowing wide connectivity with minimal custom software effort.

Ordering portals can be provided via the web or via computers configured as ordering kiosks at, for example, museums that own visual images in the catalog. The ordering kiosk computers can comprises windowless browsers, providing web access that remains dedicated to the catalog. A computer connection between the ordering kiosk and the catalog storage can have performance substantially equivalent with contemporary DSL or T1 connections to allow quick response to user interaction.

Once a user has interacted with the catalog sufficiently to make a purchase decision, the computer interface can provide for purchase and payment using contemporary electronic commerce technology. A receipt can be printed at the kiosk, provided electronically, or printed remotely for delivery to the user. The ordered reproduction can be produced immediately, at an appropriate print facility collocated with the kiosk or at a remote print facility, or can be stored for later production. For example, orders can be stored and the relatively large print files transmitted to print facilities when communication channels are most economical. The print facility, after producing the reproduction, can cause the reproduction to be delivered to the user by, for example, contemporary package delivery systems. An online status can be updated at various stages in the overall process to provide the user with an indication of the progress of the order.

The ordering process can accommodate a variety of transactions, including, for example, preferred user discounts, quantity discounts, gift certificates and credits. The catalog interaction can provide for user-sensitive interaction, for example by displaying preferentially images that previously interested the user, or by showing preferentially images associated with the specific ordering kiosk (e.g., images owned by the museum where the kiosk is located).

Example Implementation

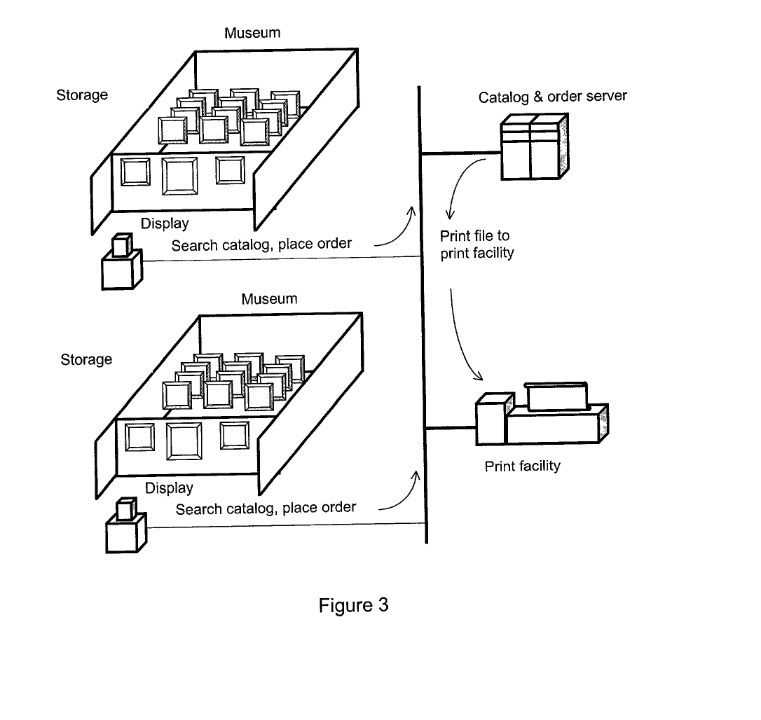

FIG. 3 is a schematic representation of a system according to the present invention. Each of a plurality of museums has rights to various works of art, some of which are on display and some of which are in storage. Each museum can also have an ordering portal, for example in the museum gift shop. The ordering portal connects with a catalog and ordering server, for example via the internet. The catalog server comprises storage for a database of information pertaining to works of art that are available for reproduction, for example the catalog can comprise information about works of art on display and in storage at the museums. The catalog server and ordering portal together allow a patron to interact with the catalog to select an image. The ordering server, which can be integrated with the catalog server, and ordering portal together allow a patron to specify and pay for a reproduction. A print file corresponding to the specified work of art can be accessed by the ordering server and transmitted to the print facility, for example using the internet. As an alternative, the print file can be stored at the print facility and an indication of the print file transmitted, exchanging print facility storage for internet communication bandwidth. The print file can control the operation of a printer that produces the desired reproduction.

Example Implementation

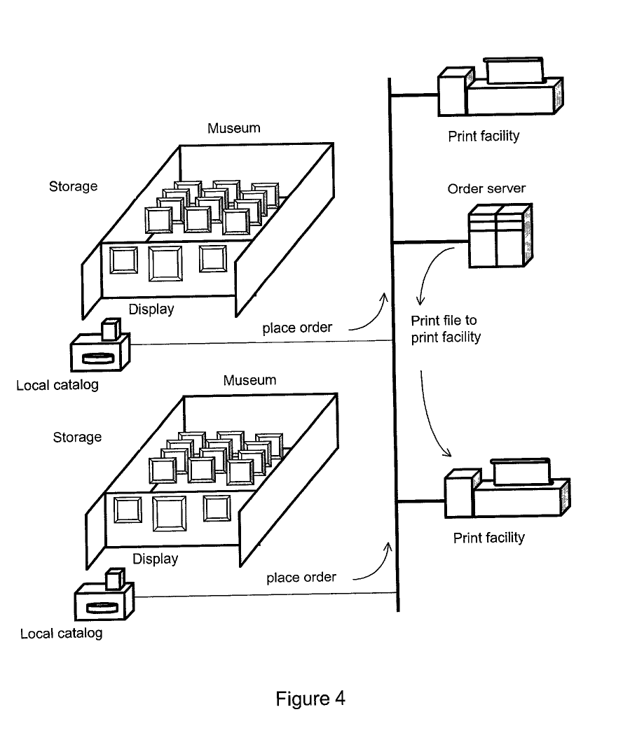

FIG. 4 is a schematic representation of a system according to the present invention. Each of a plurality of museums has rights to various works of art, some of which are on display and some of which are in storage. Each museum can also have an ordering portal, for example in the museum gift shop. A catalog of works available for reproduction can be assembled, and stored locally accessible to the ordering portal. For example, a catalog can be written to CDs or DVDs or other removable media and the media loaded into a compatible reader at the ordering portal. As another example, a catalog can be downloaded to storage at the ordering portal, for example to a disk drive, from another computer via a communications path such as the internet. A patron can interact with the catalog, browsing or searching to identify a work for which a reproduction is desired. Once the desired reproduction is specified, payment can be accepted. Payment can be accepted using electronic commerce techniques with the ordering portal in communication with an ordering server, or can be accepted using conventional payment methods at the museum gift shop, and an indication that payment has been received transmitted to the ordering server. Information identifying the desired reproduction, such as identification of the work, the format, and delivery information, can be transmitted to the ordering server, and then to a print facility along with a print file (or identification of a print file stored local to the print facility). Multiple print facilities can be used, for example, print facilities can be located in various delivery areas, and can be collocated with a museum. The ordering server functionality can also be accomplished in some instances by software at the ordering portal and software at the print facility.

Example Implementation

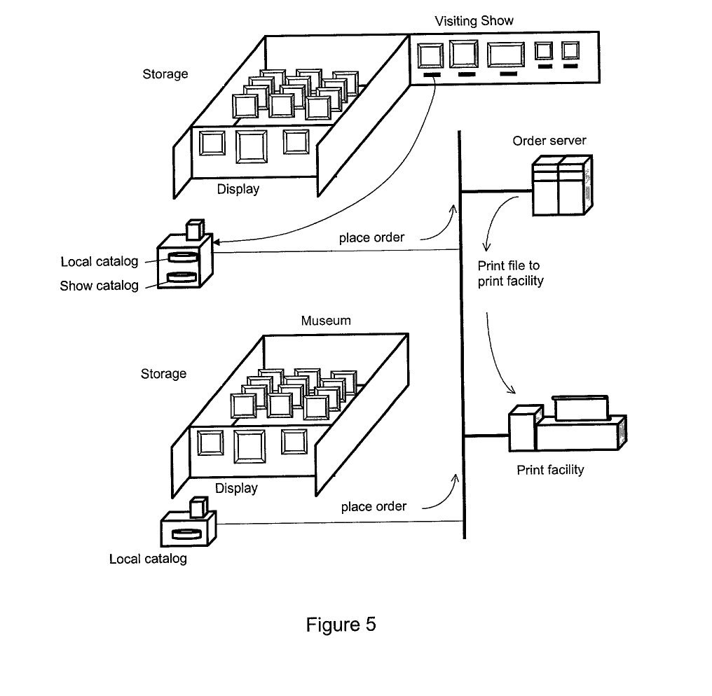

FIG. 5 is a schematic representation of a system according to the present invention. Each of a plurality of museums has rights to various works of art, some of which are on display and some of which are in storage. Each museum can also have an ordering portal, for example in the museum gift shop. One museum also has on display a traveling show of other works of art. A catalog of works available for reproduction can be assembled which includes works on display and in storage at the museums. An additional catalog can be assembled which includes works that are part of or related to the traveling show. The two catalogs can be integrated by appropriate software. The two catalogs are shown in the figure local to an ordering portal and the museum; they can local as shown, accessed via a communications path such as the internet, stored locally from communications downloads, or various combinations thereof. Patrons visiting the traveling show can order reproductions from the regular catalog and from the catalog addition corresponding to the show. Once the reproduction order has been specified, the production can be accomplished as described above.

The figure also shows an indicator associated with each image in the traveling show. A patron of the show can indicate an interest in particular works using the indicator, then have those works presented preferentially in the catalog. The system can also provide for immediate ordering of the reproduction, for example by communicating the identity of the work and the patron to an ordering server. The system can also provide for patron-specific records, for example by storing identification of works in which a patron previously indicated interest but did not order, using as an example contemporary electronic commerce shopping cart software.

A variety of techniques can be suitable for implementation of indicators. As an example, a patron can possess a bar code or infrared reader as the patron visits the show. An identifying barcode or infrared tag can be placed near each work, or near meaningful groups or subsets (e.g., those of a certain period or style) of the works displayed. A patron can indicate interest in a work by reading the barcode or tag with the reader. The readers can be in communication with the ordering portal, continuously or by download after the patron has visited the show. See, e.g., Bluetooth webpage, incorporated herein by reference. As another example, a patron can possess an identifying bar code or tag. Each work or meaningful group of works can have a reader associated with it. A patron can indicate interest in a work by presenting the patron's tag to the reader associated with the work. The various readers can communicate with the ordering portal information identifying which patrons have indicated interest in the associated works. As another example, a patron can have a code identifying the patron. Each work or meaningful group of works can have an associated keypad. A patron can indicate interest in a work by inputting the patron's code into the keypad. In all these examples, payment can be accomplished using the ordering portal, and can be accomplished by pre-payment or by credit, allowing an indication of interest in a work to also specify an order for a reproduction of the work.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1. A method of producing a reproduction of a visual image, comprising:
a) Assembling a computer-readable catalog of visual images available for reproduction;
b) Providing a plurality of ordering portals, each having access to the catalog;
c) Accepting an order from a portal, where an order comprises payment information and specification of a visual image;
d) Producing a reproduction of the specified visual image at a print facility;
e) Apportioning the payment associated with the reproduction according to the owner of the rights in the specified visual image and the ordering portal.

2. The method of claim 1, wherein assembling a computer-readable catalog comprises:
a) for each visual image to be included in the catalog, generating a record by:
i) Generating a digital image of the visual image;
ii) Generating a print file corresponding to the visual image;
iii) Associating the digital image and the print file with information identifying an owner of rights in the visual image;
b) Assembling a plurality of such records into a computer-readable database.

3. The method of claim 2, wherein generating a print file of a visual image comprises:
a) Producing a photographic reproduction of the visual image;
b) Generating a high resolution digital scan of the photographic reproduction;
c) Generating an initial print file from the digital scan;
d) Printing a test reproduction from the print file;
e) Comparing the test reproduction to the visual image, and, if the test reproduction is not a faithful reproduction, adjusting the print file and repeating from step c).

4. The method of claim 1, wherein providing a plurality of ordering portals comprises:
a) Providing a catalog computer hosting the catalog of visual images;
b) Providing, for each ordering portal, a computer interface in communication with the catalog computer;
c) Providing, for each ordering portal, a communication mechanism allowing a user of the ordering portal to access the catalog, to provide payment information, and to specify a visual image for reproduction.

5. The method of claim 1, wherein the step of producing a reproduction of the specified visual image at a print facility comprises:
a) Communicating a print file corresponding to the specified visual image to the print facility;
b) Printing a giclee of the specified visual image from the print file.

6. The method of claim 1, wherein the step of apportioning the payment associated with the reproduction comprises:
a) Determining a total amount paid from the payment information;
b) Determining a distributable amount of the total amount to be apportioned;
c) Determining an owner portion of said distributable amount;
d) Determining a portal portion of said distributable amount;
e) Communicating the owner portion according to an owner of rights in the visual image;
f) Communicating the portal portion according to an owner of the ordering portal.

7. The method of claim 2, wherein generating a record comprises associating a text with the digital image.

8. The method of claim 1, wherein a specification of a visual image comprises identification of a visual image and specification of a format for the desired reproduction.

9. The method of claim 8, wherein a format comprises specification of a size and substrate.

10. The method of claim 8, wherein a format comprises specification of parameters selected from the group consisting of: size, substrate, color, proportion, packaging, cropping, shipping destination, shipping method, and framing.

11. The method of claim 1, wherein the visual images comprise images selected from the group consisting of: photographs, works of art in museum collections, works of art in private collections, paintings, digital images, and drawings.

12. The method of claim 4, wherein the communication mechanism providing access to the catalog provides access whose characteristics depend on the identity of the ordering portal.

13. The method of claim 4, wherein the communication mechanism providing access to the catalog provides access with an interface characteristic selected from the group consisting of: browsing the catalog, searching the catalog for visual images with a specified owner of rights, searching the catalog for visual images with a specified author, searching the catalog for visual images with specified visual characteristics, searching the catalog for visual images with a specified age, and searching the catalog for visual images with associated texts containing specified characteristics.

14. The method of claim 1, wherein providing a plurality of ordering portals comprises providing kiosks in communication with the catalog via the internet.

15. A method of producing a volume of reproductions of visual images, comprising:
a) Assembling a computer-readable catalog of visual images available for reproduction;
b) Providing a plurality of ordering portals, each having access to the catalog;
c) Accepting an order from a portal, where an order comprises payment information and specification of a plurality of visual images;
d) Producing reproductions of the specified visual images at a print facility;
e) Assembling the reproductions into a volume;
f) Apportioning the payment associated with the reproductions according to the owner of the rights in the specified visual images and the ordering portal.

16. The method of claim 15, wherein the volume comprises a book.

17. The method of claim 15, wherein a visual image in the catalog has an associated text, and wherein assembling the reproductions into a volume comprises correlating each reproduction with its associated text, and assembling the reproductions and prints of their associated texts into a volume.

18. The method of claim 15, wherein assembling a computer-readable catalog comprises:
a) for each visual image to be included in the catalog, generating a record by:
i) Generating a digital image of the visual image;
ii) Generating a print file corresponding to the visual image;
iii) Associating the digital image and the print file with information identifying an owner of rights in the visual image;
b) Assembling a plurality of such records into a computer-readable database.

19. The method of claim 18, wherein generating a print file of a visual image comprises:
a) Producing a photographic reproduction of the visual image;
b) Generating a high resolution digital scan of the photographic reproduction;
c) Generating an initial print file from the digital scan;
d) Printing a test reproduction from the print file;
e) Comparing the test reproduction to the visual image, and, if the test reproduction is not a faithful reproduction, adjusting the print file and repeating from step c).

20. The method of claim 15, wherein providing a plurality of ordering portals comprises:
a) Providing a catalog computer hosting the catalog of visual images;
b) Providing, for each ordering portal, a computer interface in communication with the catalog computer;
c) Providing, for each ordering portal, a communication mechanism allowing a user of the ordering portal to access the catalog, to provide payment information, and to specify a visual image for reproduction.

21. The method of claim 15, wherein the step of producing a reproduction of the specified visual image at a print facility comprises:
a) Communicating a print file corresponding to the specified visual image to the print facility;
b) Printing a giclee of the specified visual image from the print file.

22. The method of claim 15, wherein the step of apportioning the payment associated with the reproduction comprises:
a) Determining a total amount paid from the payment information;
b) Determining a distributable amount of the total amount to be apportioned;
c) Determining an owner portion of said distributable amount;
d) Determining a portal portion of said distributable amount;
e) Communicating the owner portion according to an owner of rights in the visual image;
f) Communicating the portal portion according to an owner of the ordering portal.

23. The method of claim 18, wherein generating a record comprises associating a text with the digital image.

24. The method of claim 15, wherein a specification of a visual image comprises identification of a visual image and specification of a format for the desired reproduction.

25. The method of claim 24, wherein a format comprises specification of a size and substrate.

26. The method of claim 24, wherein a format comprises specification of parameters selected from the group consisting of: size, substrate, color, proportion, packaging, cropping, shipping destination, shipping method, and framing.

27. The method of claim 15, wherein the visual images comprise images selected from the group consisting of: photographs, works of art in museum collections, works of art in private collections, paintings, digital images, and drawings.

28. The method of claim 20, wherein the communication mechanism providing access to the catalog provides access whose characteristics depend on the identity of the ordering portal.

29. The method of claim 20, wherein the communication mechanism providing access to the catalog provides access with an interface characteristic selected from the group consisting of: browsing the catalog, searching the catalog for visual images with a specified owner of rights, searching the catalog for visual images with a specified author, searching the catalog for visual images with specified visual characteristics, searching the catalog for visual images with a specified age, and searching the catalog for visual images with associated texts containing specified characteristics.

30. The method of claim 15, wherein providing a plurality of ordering portals comprises providing kiosks in communication with the catalog via the internet.

31. The method of claim 15, wherein assembling the reproductions into a volume comprises binding the reproductions as a book.

32. An apparatus for producing reproductions of visual images, comprising:
a) A catalog server, having accessible a database of representations of visual images that are available for reproduction, where each visual image has an associated print file;
b) An order server, in communication with the catalog server;
c) A plurality of ordering portals, in communication with the catalog server and the order server;
d) A print facility, in communication with the order server;
wherein
e) The ordering portal, in communication with the catalog server, provides a user thereof with access to the database, allowing the user to identify a visual image for which a reproduction is desired;
f) The ordering portal, in communication with the order server, further allows a user thereof to specify an order, comprising specification of a visual image, a format for a desired reproduction thereof, and payment for the desired reproduction;
g) The order server accomplishes communication of orders to the print facility;
h) The order server determines an apportionment of payment according to an owner of rights in the specified visual image and the ordering portal.
